(19) United States
(12) Patent Application Publication
(10) Pub. No.: US 2024/0005276 A1
(43) Pub. Date: Jan. 4, 2024

(54) METHODS AND SYSTEMS FOR GENERATING A CHECKLIST IN SMART CITY BASED ON AN INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Junyan ZHOU, Chengdu (CN); Bin LIU, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 17/810,826

(22) Filed: Jul. 5, 2022

(30) Foreign Application Priority Data
Jul. 4, 2022 (CN) 202210776691.9

(51) Int. Cl. G06Q 10/10; G06Q 40/08; G06N 20/00

(52) U.S. Cl. CPC G06Q 10/101; G06Q 40/08; G06N 20/00; G16Y 40/10

(57) ABSTRACT

The present disclosure provides a method and a system for generating a checklist in a smart city based on an Internet of Things. The method for generating a checklist in the smart city based on the Internet of Things is executed by a verification management platform. The method includes: obtaining a query request through a user platform based on a service platform, obtaining associated person information based on a population information platform, the associated person information including target object information and related person information, obtaining a collaborative feature through a collaborative platform based on the associated person information, determining a checklist corresponding to the query request based on the collaborative feature, and feedbacking the checklist to a user through the user platform based on the service platform.

### CROSS-REFERENCE TO RELATED DISCLOSURES

This application claims priority to Chinese Patent Application No. 202210776691.9, filed on Jul. 4, 2022, the entire contents of which are hereby incorporated by reference.

### TECHNICAL FIELD

The present disclosure relates to the field of Internet of Things and cloud platform, and in particular to a method and a system for generating a checklist in a smart city based on the Internet of Things.

### BACKGROUND

With the development of information science and technology, the concept of cloud platform and its application in the Internet of Things are mentioned by more and more people. There are massive data of different users in cloud platforms and Internet of Things. When applying for services for multiple users, in order to reduce risks, relevant institutions usually need to conduct risk assessment or prediction for multiple users through massive data. How to screen out users with high risk based on massive data so that relevant institutions can further investigate users is an urgent problem that needs to be solved at present.

Therefore, it is hoped to provide a method, system and apparatus for generating a checklist in a smart city based on the Internet of Things, so that the checklist can be better determined so as to further investigate.

### SUMMARY

Some embodiments of the present disclosure provide a method for generating a checklist in a smart city based on an Internet of Things, the method is executed by a verification management platform. The method comprises obtaining a query request through a user platform based on a service platform, obtaining associated person information based on a population information platform, the associated person information including target object information and related person information, obtaining a collaborative feature through a collaborative platform based on the associated person information, determining a checklist corresponding to the query request based on the collaborative feature, and feedbacking the checklist to a user through the user platform based on the service platform.

Some embodiments of the present disclosure provide a system for generating a checklist in a smart city based on an Internet of Things, and the system includes a user platform, a service platform and a verification management platform. The verification management platform is configured to perform operations including obtaining a query request through the user platform based on the service platform, obtaining associated person information based on a population information platform, the associated person information including target object information and related person information, obtaining a collaborative feature through a collaborative platform based on the associated person information, determining a checklist corresponding to the query request based on the collaborative feature, and feedbacking the checklist to a user through the user platform based on the service platform.

Some embodiments of the present disclosure provide a non-transitory computer-readable storage medium for storing computer instructions, when reading the computer instructions in the storage medium, a computer executes the method for generating a checklist in a smart city based on an Internet of Things described above.

### BRIEF DESCRIPTION OF THE DRAWINGS

The present disclosure will be further described in the form of exemplary embodiments, and these exemplary embodiments will be described in detail with the drawings. These embodiments are not restrictive. In these embodiments, the same number represents the same structure, wherein:

FIG. 1 illustrates an application scenario diagram of a system for generating a checklist in a smart city based on an Internet of Things according to some embodiments of the present disclosure;

FIG. 2 illustrates an exemplary schematic diagram of a system for generating a checklist in a smart city based on an Internet of Things according to some embodiments of the present disclosure;

FIG. 3 illustrates an exemplary flowchart of a method for generating a checklist in a smart city based on an Internet of Things according to some embodiments of the present disclosure;

FIG. 4 illustrates an exemplary schematic diagram for determining a collaborative feature according to some embodiments of the present disclosure;

FIG. 5 illustrates an exemplary schematic diagram for determining a checklist based on the collaborative feature according to some embodiments of the present disclosure.

### DETAILED DESCRIPTION

In order to more clearly illustrate the technical solutions of the embodiments of the present disclosure, the following will briefly introduce the drawings that need to be used in the description of the embodiments. Obviously, the drawings in the following description are only some examples or embodiments of the disclosure. For those of ordinary skill in the art, without creative work, the present disclosure can be applied to the other similar application scenarios according to these drawings. Unless it is obvious from the language environment or otherwise stated, the same reference numbers in the drawings represent the same structure or operation.

It should be understood that the “system”, “device”, “unit”, and/or “module” used herein is a method for distinguishing different components, elements, parts, or assemblies of different levels. However, if other words can achieve the same purpose, the words can be replaced by other expressions.

As shown in the present disclosure and the claims, unless the context clearly suggests exceptional circumstances, the words “a”, “an”, “an”, and/or “the” do not specifically refer to the singular, but also include the plural. Generally speaking, the terms “include” and “contain” only suggest that the operations and elements that have been clearly identified are included, and these operations and elements do not constitute an exclusive list, and the method or device may also include other operations or elements.

Flowcharts are used in the present disclosure to illustrate the operations performed by the system according to the embodiments of the present disclosure. It should be understood that the preceding or following operations are not necessarily performed precisely in order. Instead, the individual operations can be processed in reverse order or simultaneously. At the same time, users can also add other operations to these processes, or remove an operation or several operations from these processes.

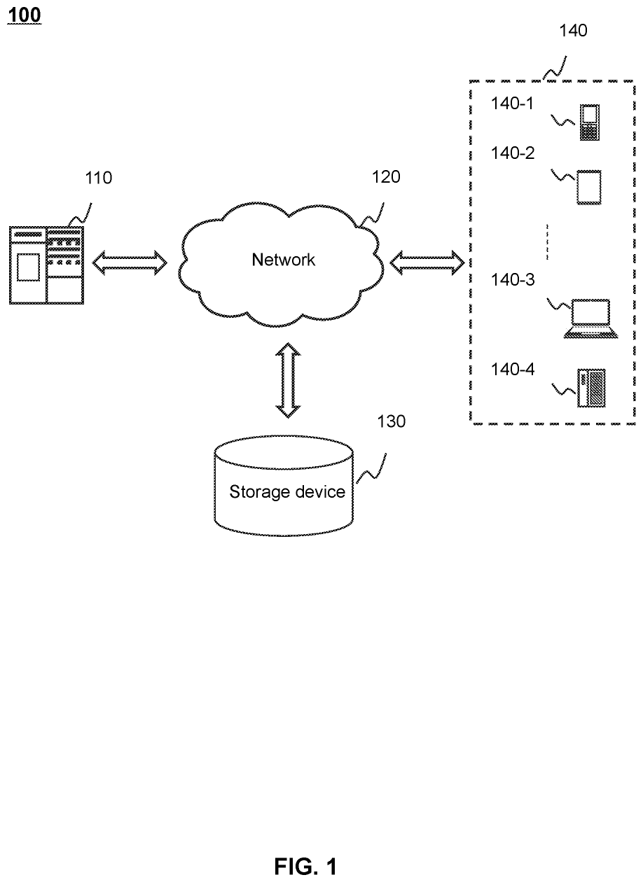

FIG. 1 illustrates an application scenario diagram of a system for generating a checklist in the smart city in a smart city based on an Internet of Things according to some embodiments of the present disclosure. As shown in FIG. 1, an application scenario 100 of a system for generating a checklist in the smart city in a smart city based on the Internet of Things may include one or more of a processing device 110, a network 120, a storage device 130, and a user terminal 140, etc.

In some embodiments, the processing device 110 may process information and/or data related to the application scenario 100 of the system for generating a checklist in the smart city based on the Internet of Things to perform one or more functions described in the application. For example, the processing device 110 may obtain query requests through a user platform and obtain associated person information based on population information platform. For another example, the processing device 110 may obtain collaborative features through the collaborative platform and determine the checklist corresponding to the query requests based on the collaborative features. In some embodiments, the processing device 110 may include one or more processing engines (e.g., a single-chip processing engine or a multi-chip processing engine). Merely by way of example, the processing device 110 may include a central processing unit (CPU), an application-specific integrated circuit (ASIC), an application-specific instruction processor (ASIP), a graphics processor (GPU), a physical processor (PPU), a digital signal processor (DSP), a field-programmable gate array (FPGA), a programmable logic circuit (PLD), a controller, a microcontroller unit, a reduced instruction set computer (RISC), and a microprocessor, or the like, or any combination thereof.

Network 120 may connect various components of the system and/or connect parts of the system with external resources. Network 120 enables communication between the various components, as well as with other components outside the system. For example, the user terminal 140 may transmit the query requests to the processing device 110 through the network 120 for processing. The processing device 110 may obtain data in the storage device 130 through the network 120. The processing device 110 may process the received query requests, and then send the checklist to the user terminal 140 through the network 120. In some embodiments, the network 120 may be any one or more of wired network or wireless network. For example, the network 120 may include a cable network, a fiber-optic network, a telecommunications network, the Internet, a local area network (LAN), a wide area network (WAN), a wireless local area network (WLAN), a metropolitan area network (MAN), a public switched telephone network (PSTN), a Bluetooth network, a ZigBee network (ZigBee), a near field communication (NFC), an in-device bus, an in-device line, and a cable connection, etc. or any combination thereof. The network connection between the various parts may be in one of the above-mentioned ways, and also be in a variety of ways. In some embodiments, the network may be various topologies such as point-to-point, shared, centralized, or the like, or any combination thereof.

The storage device 130 may be used to store data and/or instructions related to the application scenario 100 of a system for generating a checklist in the smart city based on the Internet of Things. In some embodiments, the storage device 130 may store data and/or information obtained from the processing device 110, the user terminal 140, or the like. For example, the storage device 130 may store associated person information, collaborative features, or the like. In some embodiments, the storage device 130 may include one or more storage components, and each storage component may be an independent device or a part of another device. In some embodiments, the storage device 130 may be provided in processing device 110. In some embodiments, the storage device 130 may include a random access memory (RAM), a read-only memory (ROM), a mass storage, a removable memory, a volatile a read-write memory, or the like, or any combination thereof. Exemplary, mass storage may include magnetic disks, optical disks, solid-state disks, or the like. In some embodiments, the storage device 130 may be implemented on a cloud platform.

The user terminal 140 may refer to a device or other entity used by the user related to the application scenario 100 of the system for generating a checklist in the smart city based on the Internet of Things. Users may be individuals or groups with query requests. For example, users may include related institutions (e.g., a financial institution, etc.), an individual, a business, a company, or the like. In some embodiments, the user terminal 140 may also be an agency that performs the query, e.g., a government department, or the like. For example, the user terminal 140 may be used to send a query request to the processing device 110. For another example, the user terminal 140 may receive the checklist sent by the processing device 110. In some embodiments, user terminal 140 may be one of devices with input and/or output functions such as a mobile device 140-1, a tablet computer 140-2, a laptop computer 140-3, a desktop computer 140-4, or the like, or any combination thereof. In some embodiments, the mobile device 140-1 may include a smartphone, a smart paging device, or other smart devices. In some embodiments, the user terminal 140 may include other smart terminals, such as wearable smart terminals, or the like. The above examples are only used to illustrate the breadth of the scope of the user terminal 140 equipment and not to limit its scope.

It should be noted that the application scenario 100 of the system for generating a checklist in the smart city based on the Internet of Things is provided for illustrative purposes only, and not intended to limit the scope of the application. For those skilled in the art, various modifications or changes may be made based on the description of the present disclosure. For example, the application scenario 100 of the system for generating a checklist in the smart city based on the Internet of Things may implement similar or different functions on other devices. However, such changes and modifications do not depart from the scope of the application.

The system 200 for generating a checklist in the smart city based on the Internet of Things may be implemented based on the Internet of Things system.

The Internet of Things system may be an information processing system, includes part or all of a user platform, a service platform, and a management platform. A user platform may refer to a user-led platform that may obtain users' needs and feedback information to users. A service platform may refer to a platform that may provide users with input and output services. The management platform may realize the overall planning and coordination of the connection and cooperation between various functional platforms, gather the information of the Internet of Things operation system, and provide perception management and control management functions for the Internet of Things operation system.

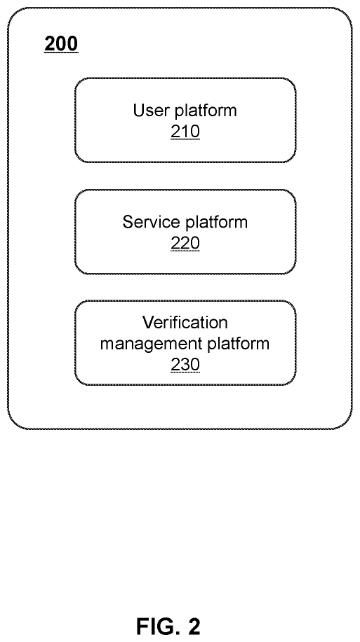

FIG. 2 illustrates an exemplary schematic diagram of a system for generating a checklist in a smart city based on an Internet of Things according to some embodiments of the present disclosure. The system 200 for generating a checklist in the smart city based on the Internet of Things may include a user platform 210, a service platform 220, and a verification management platform 230. In some embodiments, the system 200 for generating a checklist in the smart city based on the Internet of Things may be part of or implemented by the processing device 110.

The user platform may refer to a user-led platform that may obtain users' needs and feedback information to users. For example, the user platform 210 may obtain query requests. The user platform 210 may feedback the checklist to the user. In some embodiments, the user platform 210 may obtain the users' needs and feedback information to the user through the user terminal. The user platform 210 may include processing device 110 shown in FIG. 1 as well as other components.

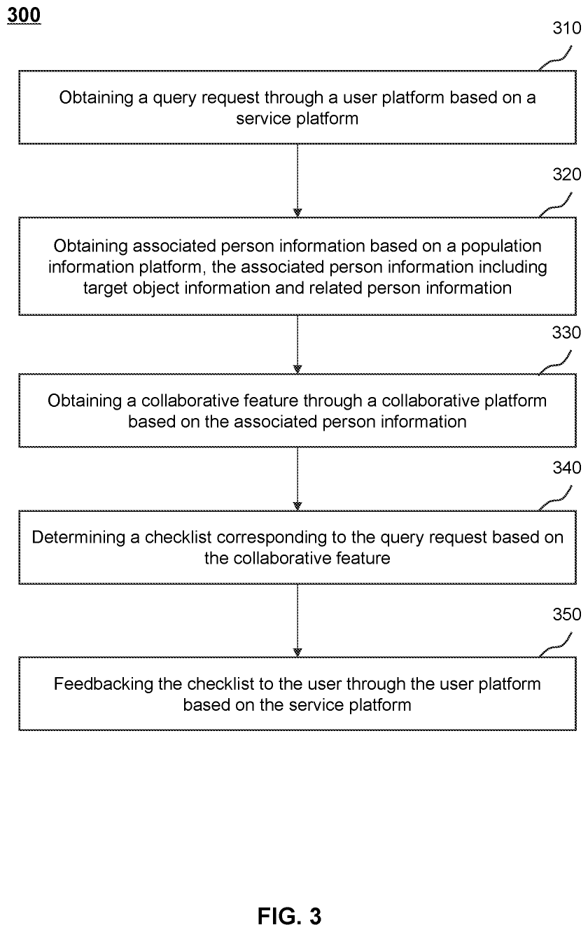

More descriptions about the user platform 210 may be found elsewhere in the present disclosure, e.g., FIG. 3 and its relevant descriptions thereof.

The service platform 220 may refer to an Internet of Things platform that may provide input and output services to users. For example, the service platform may send the checklist to the user platform.

More descriptions about the service platform 220 may be found elsewhere in the present disclosure, e.g., FIG. 3 and its relevant descriptions thereof.

The verification management platform 230 may refer to the Internet of Things platform that overall plans and coordinates the connection and cooperation between the functional platforms, gathers all the information of the Internet of Things, and provides perception management and control management for the Internet of Things operating system. For example, the verification management platform 230 may obtain query requests through the user platform based on the service platform. The verification management platform 230 may obtain associated person information based on the population information platform. The verification management platform 230 may obtain the collaborative features through the collaborative platform based on the associated person information. The verification management platform 230 may determine the checklist corresponding to the query request based on the collaborative features. The verification management platform 230 may include the processing device 110 shown in FIG. 1 as well as other components. In some embodiments, the verification management platform 230 may be a remote platform operated by management personnel, artificial intelligence, or preset rules.

More descriptions about the verification management platform 230 may be found elsewhere in the present disclosure, e.g., FIGS. 3-5 and their relevant descriptions thereof.

In some embodiments, the verification management platform 230 may communicate with one or more off-net cloud platforms. The verification management platform 230 may obtain relevant auxiliary data through an off-net cloud platform. In some embodiments, one or more off-net cloud platforms may include population information platforms, collaborative platforms, etc.

The population information platform may refer to a platform that stores population information in a certain area (e.g., the whole country, the world, etc.) and provides information query about associated persons. For example, a population information platform may store population information such as a person's gender, age, place of residence, family members, etc. In some embodiments, associated person information may be obtained through a population information platform. For example, by querying a certain object through the population information platform, the residence information of the object may be obtained. By querying the object whose residence is the same as that of the object through the population information platform, the associated person information of the object may be obtained.

More descriptions about the population information platform may be found elsewhere in the present disclosure, e.g., FIG. 3 and its relevant descriptions thereof.

A collaborative platform may refer to a platform that may provide assistance information for generating a checklist. For example, a collaborative platform may provide collaborative information that may be used for generating the checklist. In some embodiments, the collaborative platform may obtain collaborative features based on the associated person information. In some embodiments, the collaborative platform may include at least one of a social insurance platform and a medical insurance platform.

More descriptions about the collaborative platform may be found elsewhere in the present disclosure, e.g., FIGS. 3-5 and their relevant descriptions thereof.

In some embodiments, the system 200 for generating a checklist in the smart city based on the Internet of Things may be applied to various scenarios of risk prediction management. In some embodiments, the system 200 for generating a checklist in the smart city based on the Internet of Things may separately obtain relevant data of risk prediction in various scenarios, so as to obtain risk prediction management strategies in each scenario, such as data related to fraud prevention, data fraud prevention, credit evaluation, etc. In some embodiments, the system 200 for generating a checklist in the smart city based on the Internet of Things may obtain risk prediction management strategies for the entire region (such as the whole country, the whole world, etc.) based on various related data obtained from risk prediction in various scenarios.

Various scenarios of risk prediction management may include fraud prevention scenario, data fraud prevention scenario, credit evaluation scenario, or the like. For example, it may include fraud prevention risk prediction management, data fraud prevention risk prediction management, credit evaluation risk prediction management, or the like. It should be noted that the above scenarios are only examples, and do not limit the specific application scenarios of the system 200 for generating a checklist in the smart city based on the Internet of Things. Those skilled in the art may apply the system 200 for generating a checklist in the smart city based on the Internet of Things to any other suitable scenarios on the basis of the content disclosed in this embodiment.

In some embodiments, the system 200 for generating a checklist in the smart city based on the Internet of Things may be applied to fraud prevention risk prediction management. When applied to fraud prevention risk prediction management, the user platform may obtain the user's fraud prevention requests, such as fraud prevention requests of multiple certain target objects that meet the query conditions. The user platform may send the user's fraud prevention request to the service platform. The service platform may send the user's fraud prevention request to the verification management platform. The verification management platform may obtain relevant data (such as a checklist corresponding to multiple target objects) through one or more off-net cloud platforms. Based on the processing of the checklist, strategies or instructions related to the fraud prevention risk prediction management may be determined, such as the audit strength of the multiple target objects.

In some embodiments, the system 200 for generating a checklist in the smart city based on the Internet of Things may be applied to data fraud prevention risk prediction management. When applied to data fraud prevention risk prediction management, the user platform may obtain the user's data fraud prevention requests. For example, data fraud prevention requests of multiple certain target objects that meet the query conditions. The user platform may send the user's data fraud prevention request to the service platform. The service platform may send the user's data fraud prevention request to the verification management platform. The verification management platform may obtain relevant data (such as a checklist corresponding to multiple target objects) through one or more off-net cloud platforms. Based on the processing of the checklist, strategies or instructions related to data fraud prevention risk prediction management may be determined, such as whether the data of the multiple target objects is fraudulent, etc.

In some embodiments, the system 200 for generating a checklist in the smart city based on the Internet of Things may be applied to credit evaluation risk prediction management. When applied to credit evaluation risk prediction management, the user platform may obtain the user's credit evaluation requests, such as a credit evaluation requests of multiple target objects that meet the query conditions. The user platform may send the user's credit evaluation request to the service platform. The service platform may send the user's credit evaluation request to the verification management platform. The verification management platform may obtain relevant data (such as a checklist corresponding to multiple target objects) through one or more off-net cloud platforms. Based on the processing of the checklist, strategies or instructions related to the credit evaluation risk prediction management may be determined, such as the credit of the multiple target objects.

In some embodiments, the system 200 for generating a checklist in the smart city based on the Internet of Things may be composed of a plurality of subsystems of risk prediction management, and each subsystem may be applied to one scenario. The system 200 for generating a checklist in the smart city based on the Internet of Things may comprehensively manage and process the data obtained and output by each subsystem, and then obtain relevant strategies or instructions for assisting risk prediction management.

For example, the system 200 for generating a checklist in the smart city based on the Internet of Things may include a subsystem of fraud prevention risk prediction management, a subsystem of fraud prevention risk prediction management, and a subsystem of credit evaluation risk prediction management. The system 200 for generating a checklist in the smart city based on the Internet of Things may be the superior system of each subsystem.

The following will illustrate in detail an example about that the system 200 for generating a checklist in the smart city based on the Internet of Things manages each subsystem and obtain corresponding data based on the subsystem so as to obtain the strategies for risk prediction management.

The system 200 for generating a checklist in the smart city based on the Internet of Things may obtain checklist such as fraud prevention of the target object based on the subsystem of fraud prevention risk prediction management. The data such as data fraud prevention of the target object may be obtained based on the subsystem of data fraud prevention risk prediction management. The data such as credit evaluation of the target object may be obtained based on the subsystem of credit evaluation risk prediction management.

The system 200 for generating a checklist in the smart city based on the Internet of Things may perform summary and processing on the checklist after obtaining the above-mentioned checklist. The evaluation data related to risk prediction management may made through the verification management platform based on the processing of the checklist.

For example, the verification management platform may determine the audit strength of multiple target objects based on the date such as fraud prevention of the target object. The verification management platform may determine whether the data of the multiple target objects is fraudulent based on the data such as data fraud prevention of the target object. The verification management platform may determine the credit of the multiple target objects based on the data such as credit evaluation of the target object. The verification management platform may determine whether the data of the multiple target objects is fraudulent and the credit of the multiple target objects based on the audit strength of the above-mentioned target object. The verification management platform may further determine the audit strength of the multiple target objects.

For those skilled in the art, after understanding the principle of the system, it is possible to move the system to any other suitable scenario without departing from this principle.

The following will give specific descriptions about the system 200 for generating a checklist in the smart city based on the Internet of Things by taking the system 200 for generating a checklist in the smart city based on the Internet of Things applied to the fraud prevention risk prediction management scenario as an example.

In some embodiments, the verification management platform 230 may be configured to obtain query requests through a user platform based on a service platform. The associated person information may be obtained based on a population information platform, and the associated person information may include target object information and related person information. The collaborative feature may be obtained through the collaborative platform based on the associated person information. The checklist corresponding to the query request may be determined based on the collaborative features. The checklist may be feedback to the user through the user platform based on the service platform.

In some embodiments, a collaborative feature may be determined through a collaborative platform processing the collaborative information of the associated person by an embedded layer.

In some embodiments, the collaborative platform may include at least one of a social insurance platform and a medical insurance platform. The social insurance collaborative feature may be determined through the social insurance platform processing a social insurance feature of associated person by the social insurance embedded layer. The medical insurance collaborative feature may be determined through the medical insurance platform processing medical insurance features of associated person by the medical insurance embedded layer.

In some embodiments, the social insurance platform may obtain the social insurance features of the associated person through a social insurance knowledge graph. In some embodiments, the medical insurance platform may obtain the medical insurance feature of the associated person based on a medical insurance knowledge graph.

In some embodiments, the social insurance platform may obtain the social insurance feature of the associated person based on the social insurance knowledge graph. In some embodiments, the medical insurance platform may obtain the medical insurance feature of the associated person based on the medical insurance knowledge graph.

In some embodiments, the evaluation value may be determined through the verification management platform 230 processing the collaborative feature based on an evaluation model. The evaluation model may be a machine learning model.

In some embodiments, the input of the evaluation model may include at least one of a medical insurance collaborative feature and a social insurance collaborative feature.

In some embodiments, the verification management platform 230 may be configured to obtain the evaluation model through a joint multi-party security training of multiple embedded layers and the evaluation model.

In some embodiments, the social insurance management platform, the medical insurance management platform, and the verification management platform as one of multiple parties may perform a collaborative training. The social insurance management platform may obtain the social insurance embedded layer. The medical insurance management platform may obtain the medical insurance embedded layer. The verification management platform may obtain the evaluation model.

It should be understood that the system and its platform shown in FIG. 2 may be implemented in various ways. For example, in some embodiments, the verification management platform 230 may be provided in processing device 110 shown in FIG. 1.

It should be noted that the above descriptions of the system and its components is only for the convenience of description, which is not limit the present specification to the scope of the illustrated embodiments. It may be understood that for those skilled in the art, after understanding the principle of the system, it is possible to arbitrarily combine the various components, or form a subsystem to connect with other components without departing from the principle. For example, each component may share one storage device, and each component may also have its own storage device. Such deformations are within the scope of protection of the present disclosure.

FIG. 3 illustrates an exemplary flowchart of a method for generating a checklist in a smart city based on an Internet of Things according to some embodiments of the present disclosure. As shown in FIG. 3, the process 300 includes the following operations. In some embodiments, process 300 may be performed by verification management platform 230.

In operation 310, a query request may be obtained through a user platform based on a service platform.

The query request may refer to information about query conditions. When a user sends a query request, some basic information about query conditions may be needed to be provided. The basic information about query conditions may include name, ID number, place of residence, etc.

In some embodiments, the verification management platform 230 may obtain the query request through the user platform based on the service platform. For example, a user may enter query requests through the user platform. The service platform may obtain the query request input by the user through the user platform. The service platform may send related query requests and basic information of the target object to the verification management platform. In some embodiments, the verification management platform 230 may obtain multiple target objects that satisfy the query request based on the query request. The verification management platform may obtain information related to the target objects based on multiple target objects. For example, the verification management platform may obtain associated person information based on the population information platform, and the associated person information may include target object information and related person information.

In operation 320, associated person information may be obtained based on a population information platform, and the associated person information includes target object information and related person information.

An associated person may include a target object and a related person. A related person may refer to a person who has a certain relationship with the target object. For example, the related person may be the relative of the target object, etc. The associated person information may include target object information and related person information. For example, the associated person information may include the place of residence, relationship information, or the like of the target object and the related person. The place of residence of the related person and the target object may be the same or different. The relationship information may refer to the relationship between the related person and the target object. For example, the relationship between the related person and the target object may be a kinship relationship (e.g., husband and wife, father and son, mother and daughter, brother and sister, etc.).

In some embodiments, the verification management platform 230 may obtain associated person information through a population information platform. For example, the verification management platform may obtain multiple target objects that meet the query conditions based on the query conditions in the query request. The verification management platform may obtain the associated person information corresponding to each target object based on multiple target objects. The verification management platform may input the query conditions (such as age, gender, occupation, etc.) into the population information platform. The population information platform may search and query based on the above information, obtain multiple target objects that meet the query conditions, and then obtain the associated person information corresponding to each target object respectively. The population information platform may obtain related person who have kinship with each target object. Through one or more related persons, the population information platform may obtain associated person information such as each target object and related persons. The verification management platform then obtains the associated person information through the population information platform.

In operation 330, a collaborative feature may be obtained through a collaborative platform based on the associated person information.

A collaborative feature may refer to a feature that may represent information about one or more aspects of a target object and a related person. For example, various aspects of information may include the information such as medical insurance information, social insurance information of the target object and related person.

In some embodiments, the collaborative feature may be represented by a feature vector. A feature vector may represent a collaborative feature of target object or related person. Different elements in the feature vector may represent different aspects of the information such as the target object or the related person.

The verification management platform may determine the credit risk of the target object through the collaborative feature. A collaborative feature may reflect various aspects of information such as a target object or a related person. For example, various information may include whether the credit card is overdue, whether to pay social insurance, whether there is a bad loan record, etc. Exemplarily, the feature vector is (a, b, c), and the elements in the feature vector are represented by 0 or 1, where 0 means no and 1 means yes. Element “a” means whether the credit card is overdue, element “b” means whether to pay social insurance, and element “c” means whether there is a bad loan record. The feature vector 1 corresponding to the collaborative feature 1 of the target object 1 and the related person of the target object 1 is (0, 1, 0), and the feature vector 1 means that the target object 1 and the related person of the target object 1 have no overdue credit cards, pay social insurance, and have no loan. The feature vector 2 corresponding to the collaborative feature 2 of the target object 2 and the related person of the target object 2 is (1, 1, 1), and the feature vector 2 means that target object 2 and the related person of target object 2 have overdue credit cards, pay social insurance, and have loan.

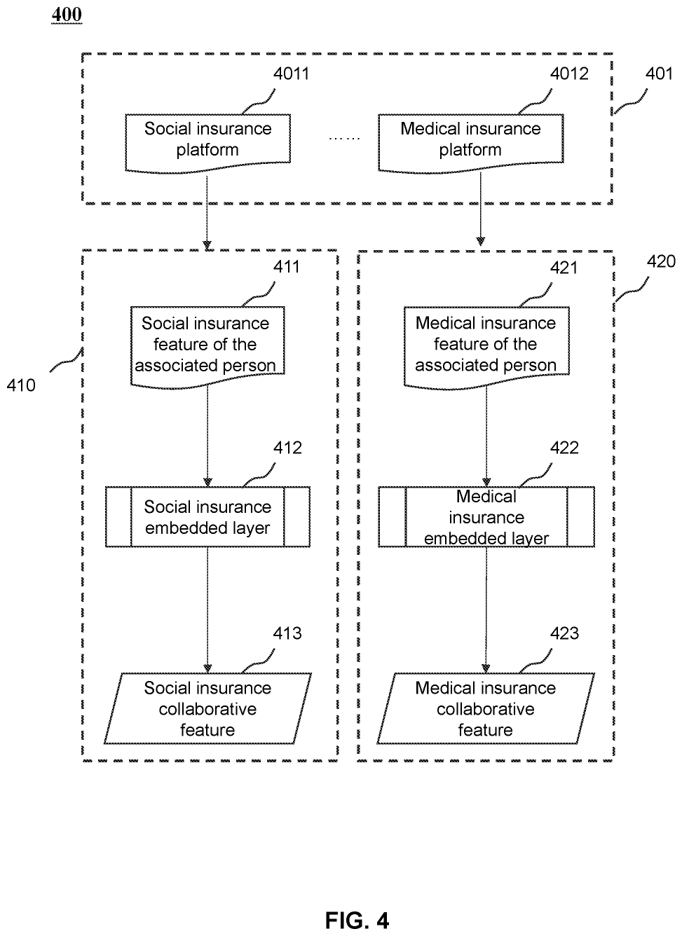

In some embodiments, a collaborative feature may include a medical insurance collaborative feature and a social insurance collaborative feature. More descriptions about the medical insurance collaborative feature and the social insurance collaborative feature may be found elsewhere in the present disclosure, e.g., FIG. 4 and its relevant descriptions thereof.

In some embodiments, the verification management platform 230 may obtain the collaborative features through a collaborative platform based on the associated person information. For example, the verification management platform may send the associated person information to the collaborative platform through the network 120 and make a request for obtaining collaborative features. The collaborative platform may receive the above request and obtain the collaborative features of the target object and the related person based on the associated person information. The collaborative platform may send the obtained collaborative features of the target object and the related person to the verification management platform.

In some embodiments, the collaborative feature may be determined through the collaborative platform processing the collaborative information of the associated person by the embedded layer.

In some embodiments, the embedded layer may process collaborative information of the associated person. The processed collaborative information of the associated person may be transformed. Through the transformation of the embedded layer, the true value of the collaborative information of the associated person may be covered or hidden without being disclosed. In some embodiments, the input of the embedded layer may include collaborative information of the associated person, and the output of the embedded layer may include a collaborative feature.

The collaborative information of the associated person may refer to the related information that may reflect different aspects about the target object and the related person. For example, the collaborative information of the associated person may reflect the social insurance information of the target object and the related person, the medical insurance information of the target object and the related person, etc.

In some embodiments, the collaborative feature may be determined through the collaborative platform processing the collaborative information of the associated person by the embedded layer. For example, the collaborative platform may input the collaborative information of the associated person into the embedded layer, and the embedded layer may output the collaborative features.

In some embodiments, the verification management platform 230 may obtain different collaborative features through different collaborative platforms. Collaborative platforms may include social insurance platforms, medical insurance platforms, etc. The social insurance collaborative feature may be determined through the social insurance platform processing the social insurance feature of associated person by the social insurance embedded layer. The medical insurance collaborative feature may be determined through the medical insurance platform processing the medical insurance feature of associated person by the medical insurance embedded layer. More descriptions about the specific contents of determining the feature of social insurance collaborative feature and medical insurance collaborative feature may be found elsewhere in the present disclosure, e.g., FIG. 4 and its relevant descriptions thereof.

In some embodiments of the present disclosure, the collaborative feature may be determined through the collaborative platform processing the collaborative information of the associated person by the embedded layer. The related information of the target object and the related person may be changed, and the true value of the related information may be covered or hidden without being disclosed, so as to ensure the security and confidentiality of the related information of the target object and related person.

In operation 340, a checklist corresponding to the query request may be determined based on the collaborative feature.

In some embodiments, the verification management platform 230 may determine the evaluation value of each target object based on the cooperative features corresponding to multiple target objects respectively. The evaluation value may refer to a value that may reflect the credit risk of the target object. In some embodiments, the evaluation value may be represented numerically or textually. For example, the evaluation value may be represented by a value of 0-10. The closer the evaluation value is to 10, it is indicated that the credit risk is higher and the credit of the target object is worse. The closer the evaluation value is to 0, it is indicated that the credit risk is lower and the credit of the target object is better. For another example, the evaluation value may be represented by text. A text may include a low credit risk, a moderate credit risk, a high credit risk, etc. A low credit risk means that the credit of the target object is good, a moderate credit risk means that the credit of the target object is general, and a high credit risk means the credit of the target object is poor.

In some embodiments, the verification management platform 230 may determine the evaluation value based on a collaborative feature. For example, the collaborative feature may reflect that the target object 1 and the related person of the target object 1 have good credit and no bad records. The verification management platform 230 may determine that the evaluation value of the target object 1 is low (e.g., the evaluation value is 2). For another example, the collaborative feature may reflect that one or more of the target object 2 and the related persons of the target object 2 have poor credit, and the credit card is overdue. The verification management platform 230 may determine that the evaluation value of the target object 2 is relatively high (e.g., the evaluation value being 8).

In some embodiments, the verification management platform 230 may determine the evaluation value based on the collaborative feature and the collaborative feature threshold. The collaborative feature threshold may refer to a threshold related to collaborative feature preset by the verification management platform. The collaborative feature threshold may include 10 collaborative feature thresholds. Different collaborative feature thresholds may correspond to different evaluation values respectively. For example, the evaluation value corresponding to the value less than or equal to the collaborative feature threshold 1 is 1. The evaluation value corresponding to the value greater than the collaborative threshold 1 and less than or equal to the collaborative feature threshold 2 is 2. The evaluation value corresponding to the value greater than the collaborative threshold 7 and less than or equal to the collaborative feature threshold 8 is 8 and so on. As described in the above example, if the collaborative features of target object 1 and the related person of target object 1 are greater than the collaborative feature threshold 1 and less than the collaborative feature threshold 2, the verification management platform 230 may determine that the evaluation value of target object 1 is 2.

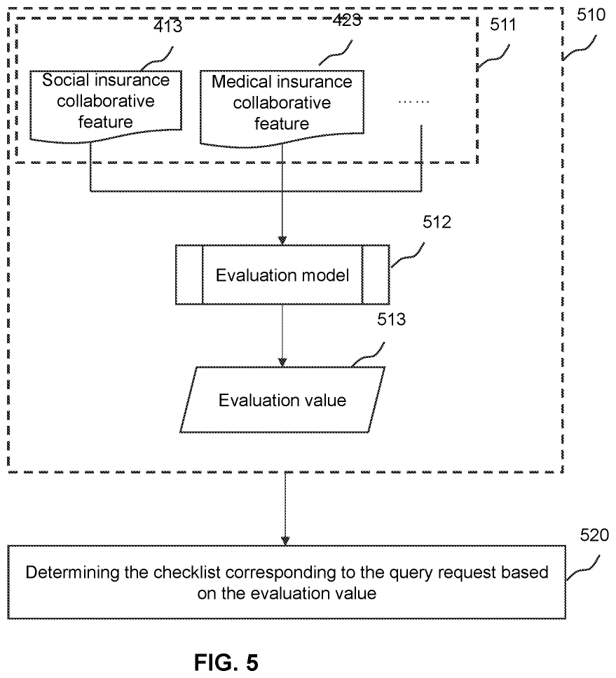

In some embodiments, the evaluation value may be determined through the verification management platform 230 processing the collaborative feature based on the evaluation model. The evaluation model may be a machine learning model. The verification management platform 230 may determine a checklist corresponding to the query request based on the evaluation value. More descriptions about determining the collaborative feature by processing the collaborative feature based on the checklist corresponding to the query request may be found elsewhere in the present disclosure, e.g., FIG. 5 and its relevant descriptions thereof.

In some embodiments, the verification management platform 230 may determine the checklist corresponding to the query request based on the evaluation values corresponding to multiple target objects respectively. The checklist may refer to the check results of multiple target objects that satisfy the query conditions. The verification management platform may rank target objects based on the evaluation value corresponding to each target object to generate a checklist. The rank may be done according to the size of the evaluation value, for example, the smaller the evaluation value is, the higher the rank is. The checklist may reflect the respective credit risks of multiple target objects that meet the query conditions. A checklist may include multiple relevant information about multiple target objects. For example, the checklist may include the evaluation value of each target object that satisfies the query condition, the rank of each target object among the multiple target objects, the annotation of each target object, and the evaluation reference content of each target object at least one of etc. Exemplarily, the relevant information of the target object A in the checklist is the evaluation value being 3, the rank being 2, the target object being marked with high risk and needing to be paid attention to, the reference content being 5 times overdue credit card, bad loan record being 1, etc.

In operation 350, the checklist may be feedbacked to the user through the user platform based on the service platform.

A related institution may send query requests to the verification management platform. The related institution may refer to institution with inquiry needs, such as financial institution, etc. The related institution may determine the audit strength of multiple target objects according to the checklist (the checklist includes the rank of the evaluation values corresponding to multiple target objects) fed back by the verification management platform. For example, the audit strength may include no audit, normal audit, key audit, etc. Exemplarily, the checklist may show that a certain target object has low credit risk and good credit. The related institution may determine the audit strength as no audit. The evaluation value may show that a certain target object has high credit risk and poor credit. The related institutions may determine the review intensity as the key audit.

In some embodiments, the related institution may determine the audit strength by a preset standard. For example, the preset standard is that the evaluation value in a checklist is less than or equal to 3, and the audit strength is no audit. The preset standard is that the evaluation value in a checklist is greater than 3 and less than or equal to 7, and the audit strength is normal audit. The preset standard is that the evaluation value in a checklist is greater than 7 and less than or equal to 10, and the audit strength is the key audit.

In some embodiments, the verification management platform may send the checklist to the user platform through the service platform. The user platform may feedback the checklist to the user. For example, the verification management platform may send the checklist (the rank of evaluation values of multiple target objects) to the service platform. The service platform may send the checklist to the user platform. The user platform may send the evaluation value of the target object to the user. The user may determine the further audit strength of the multiple target objects based on the checklist.

In some embodiments of the present disclosure, through massive data, the verification management platform may determine the checklist, which is more consistent with the laws of historical data. The user may determine the further audit strength of the multiple target objects based on the checklist. Through the above method, it is helpful for users to understand the credit status of the multiple target objects and reduce the risk of fraud. Users may save the pre-order analysis of massive data.

FIG. 4 illustrates an exemplary schematic diagram for determining a collaborative feature according to some embodiments of the present disclosure. As shown in FIG. 4, the process 400 includes the following operations. In some embodiments, the process 400 may be performed by verification management platform 230.

In some embodiments, collaborative platform 401 may include at least one of a social insurance platform 4011 and a medical insurance platform 4012.

In operation 410, the social insurance collaborative feature may be determined through the social insurance platform processing the social insurance feature of the associated person by the social insurance embedded layer.

The social insurance platform 4011 may refer to a platform that may provide assistance information about social insurance. The social insurance platform may include the social insurance information of people from one or more social insurance institutions.

In some embodiments, the social insurance embedded layer 412 may process the social insurance features 411 of the associated person. The social insurance feature of the processed associated person may be transformed. Through the transformation of the social insurance embedded layer, the true value of the social insurance feature of the associated person may be covered or hidden without being disclosed. In some embodiments, the input of the social insurance embedded layer 412 may include the social insurance feature 411 of the associated person. The output of the social insurance embedded layer may include the social insurance collaborative feature 413.

The social insurance feature 411 of the associated person may refer to a feature that may represent the social insurance related information of the target object and the related person. The social insurance related information may include social insurance related information of the target object and the related person. The social insurance related information may include the count of insured areas, the social insurance payment information of each insured area, or the like. The count of insured areas may refer to the areas in which the target object or related person has participated in social insurance. The social insurance payment information of each insured area may include a total count of months of social insurance payment, a current count of consecutive months of social insurance payment, a payment type, a payment base, an account balance, the count of low-income subsidy applications, the count of low-income subsidy refusals, an existence of low-rent housing, the count of claiming unemployment security, the amount of claiming unemployment security, etc. The payment types may include personal payment or company payment.

The social insurance collaborative feature 413 may refer to the social insurance feature processed by the social insurance embedded layer. For example, the social insurance feature 1 of the associated person may be (3, 86, 17, A, 4000, . . . ). The social insurance feature 1 of the associated person may indicate that the count of insured areas of the target object is 3. The total count of months of social insurance payment of the target object may be 86 months. The current count of consecutive months of social insurance payment of the target object may be 17 months. The payment type of the target object may be class A. The payment base of the target object may be 4000, and so on. The social insurance collaborative feature 1 corresponding to the social insurance feature 1 of the associated person may be (a, b, c, d, e, . . . ). In social insurance collaborative feature 1, the “a” may indicate that the count of insured areas of the target object is 3, the “b” may indicate that the total count of months of social insurance payment of the target object is 86 months, the “c” may indicate that the current count of consecutive months of social insurance payment of the target object is 17 months, the “d” may indicate that the payment type of the target object is class A, and the “e” may indicate that the payment base of the target object is 4000, etc.

In some embodiments, the social insurance collaborative feature 413 may be determined through the social insurance platform 241 processing the social insurance feature 411 of the associated person by the social insurance embedded layer 412. For example, the social insurance platform may input the social insurance feature of the associated person into the social insurance embedded layer, and the social insurance embedded layer may output the social insurance collaborative feature.

More descriptions regarding the training process of the social insurance embedded layer may be found elsewhere in the present disclosure, e.g., FIG. 5 and the relevant descriptions thereof.

In some embodiments, the social insurance platform may obtain the social insurance feature of the associated person based on a social insurance knowledge graph.

The social insurance knowledge graph may reflect the relationship between multiple people and multiple social insurance institutions. In some embodiments, the social insurance knowledge graph may include nodes and edges. The edge of the social insurance knowledge graph may refer to the relationship between nodes. The nodes may include people nodes and social insurance institution nodes, etc. The node attributes of people nodes may include address information, bank flow, income information, credit data, etc. The node attributes of the social insurance institution nodes may include address information, etc.

In some embodiments, the edges of the social insurance knowledge graph may include multiple types of edges. For example, the immediate family type, the same address type, the social insurance related type, etc. The edge of the immediate family type is the edge between people, which may reflect the relationship between people. The edge attributes of the immediate family type may include husband and wife, father and son, mother and daughter, brother and sister, etc. The edges of the same address type are also the edges between people. For example, by querying the address information of two persons A and B, it may be determined that the addresses of A and B are the same, so there is an edge between A and B as “A-same address-B”. The edge of the social insurance related type is the edge between the people and the social insurance institution, which may reflect the relationship between the people and the social insurance institution. For example, the edge of social insurance related type may be configured to describe a people's social insurance related information. The edge attributes of social insurance related types may include a total count of months of social insurance payment, a current count of consecutive months of social insurance payment, a payment type (e.g., personal payment or company payment), a payment base, an account balance, the count of low-income subsidy applications, the count of low-income subsidy refusals, an existence of low-rent housing, the count of claiming unemployment security, the amount of claiming unemployment security, etc.

In some embodiments, the social insurance platform may obtain the social insurance feature of the related person based on a social insurance knowledge graph.

The social insurance feature of the associated person may include the social insurance feature of the target object and the social insurance feature of the related person. In some embodiments, the social insurance feature of the target object may be obtained through related information such as the count of insured areas of the target object, social insurance payment information of each insured area, etc. The social insurance platform may determine the count of insured areas through the count of target objects and the count of edges existed in the social insurance structure. For example, in the social insurance knowledge graph, each of the target object and the three social insurance structures has one edge. The social insurance platform may determine that the count of insured areas of the target object is 3.

The social insurance platform may determine the social insurance payment information of each insured area by the attribute of the edge between the target object and the corresponding social insurance institution. For example, the social insurance platform may query the edge attributes of the target object whose neighbor degree is 1 and the edge type is a social insurance related type through the social insurance knowledge graph. The social insurance platform may further determine the social insurance payment information of each insured area corresponding to the target object.

The neighbor degree may refer to the distance relationship between two nodes. For example, the neighbor degree may include 1, 2, 5, etc. The neighbor degree 1 means that two nodes are directly connected. For example, the target object is directly linked to a social insurance institution. The neighbor degree 2 means that two nodes are connected through another node. For example, the target object is A, the target object's wife is B, and the wife's younger brother is C. A, B and C, the connection mode of 3 nodes is A-B-C. The neighbor degree of target object A and his wife's brother C is 2.

In some embodiments, the social insurance platform may input related information such as the count of insured regions of the target object obtained, and the social insurance payment information of each insured region into the social insurance embedded layer. The social insurance embedded layer outputs the social insurance feature vector of the target object. The social insurance feature vector may represent the social insurance feature of the target object or related person.

Different elements in the social insurance feature vector may represent different social insurance related information of the target object or related person. For example, in a social insurance feature vector (a, b, c, . . . ), the element “a” may represent the count of insured areas of the target object; the element “b” may represent the social insurance payment information of one of the insured areas; the element “c” may represent the social insurance payment information of another insured area different from b.

In some embodiments, the social insurance platform may determine the related person of the target object by the neighbor degree between different people and the target object. The social insurance feature of the related person may be obtained through the related information such as the count of insured areas of the related person of the target object, and the social insurance payment information of each insured area. For example, the social insurance platform may set the maximum neighbor degree. The maximum neighbor degree may refer to the maximum value of the neighbor degree between the related person and the target object. For example, the maximum neighbor degree may be 3, 5, etc.

Exemplarily, the maximum neighbor degree is 3. The social insurance platform may obtain the related person of the target object through the social insurance knowledge graph. The social insurance platform may obtain edges whose neighbor degree with the target object is less than or equal to 3 and whose edge type is the immediate family type or the same address type. The social insurance platform may obtain the people nodes connected to the edge. The people corresponding to the people node may be the related person of the target object. The social insurance platform may obtain related information such as the count of insured areas and the social insurance payment information of each insured area.

In some embodiments, the social insurance platform may input related information such as the count of insured areas of the related person obtained, the social insurance payment information of each insured area into the social insurance embedded layer. The social insurance embedded layer may output the social insurance feature vector of the related person.

In some embodiments, the social insurance platform may obtain social insurance collaborative feature by means of neighbor degree weighting. The neighbor degree weighting may refer to that the weight of the social insurance related information of the related person is the smaller and the related person is connected by the edge with the larger the neighbor degree value. For example, the social insurance platform may weight the social insurance feature vectors of the target object and related person to determine the social insurance collaborative feature. Exemplarily, the social insurance feature vector of the target object is A1, and the corresponding weight is 0.4. The social insurance feature vector of related person 1 is A2, the neighbor degree to the target object is 1, and the corresponding weight is 0.3. The social insurance feature vector of related person 2 is A3, the neighbor degree to the target object is 2, and the corresponding weight is 0.2. The social insurance feature vector of related person 3 is A4, the neighbor degree with the target object is 3, and the corresponding weight is 0.1. The social insurance collaborative feature is A1*0.4+A2*0.3+A3*0.2+A4*0.1. The social insurance platform may preset the weight according to the actual needs.

In some embodiments of the disclosure, the social insurance feature of the target object and the related person may be obtained based on the social insurance knowledge graph to further obtain the social insurance collaborative feature. Through the above method, the relevant social insurance information of the target object and related person may be comprehensively considered in various aspects. It saves the need for users to perform pre-order analysis of massive data in social insurance, which is beneficial to improve the accuracy of the checklist of subsequent target objects. A checklist that is more consistent with the laws of historical data about social insurance may be obtained through generating a checklist from massive data about social insurance.

In operation 420, the medical insurance collaborative feature may be determined through the medical insurance platform processing the medical insurance feature of the associated person by the medical insurance embedded layer.

A medical insurance platform 4012 may refer to a platform that may provide assistance information about medical insurance. The medical insurance platform may include medical insurance information of people from one or more medical insurance institutions.

In some embodiments, the medical insurance embedded layer 422 may process the medical insurance feature 421 of the associated person. The medical insurance feature of the processed associated persons may be transformed. Through the transformation of the medical insurance embedded layer, the true value of the medical insurance feature of the associated person may be covered or hidden without being disclosed. In some embodiments, the input of the medical insurance embedded layer 422 may include the medical insurance feature 421 of the associated person. The output of the medical insurance embedded layer may include medical insurance collaborative feature 423.

The medical insurance feature 421 of the related person may refer to a feature that represents the medical insurance related information of the target object and the associated person. The medical insurance related information may include the medical insurance related information of the target object and the related person. The medical insurance related information may include the count of insured areas, the medical insurance related information of each insured area, etc. The count of insured areas may refer to the areas in which the target object or related person has participated in medical insurance. The medical insurance related information of each insured area may include the count of doctor visits, the count of serious illnesses, the severity level, the count of medical insurance reimbursements, and the total amount of medical insurance reimbursements, etc.

The medical insurance collaborative feature 423 may refer to the medical insurance feature processed by the medical insurance embedded layer. For example, the medical insurance feature 1 of the associated person may be (2, 10, 2, 1, 5, . . . ). The medical insurance feature 1 of the associated person may indicate that the count of insured areas of the target object is 2, the count of doctor visits of the target subject is 10, the count of serious illnesses of the target subject is 2, the severity level of the target object is 1, and the count of medical insurance reimbursements of the target object is 5. The medical insurance collaborative feature 1 corresponding to the medical insurance feature 1 of the associated person may be (A, B, C, D, E, . . . ). In the medical insurance collaborative feature 1, “A” may indicate that the count of insured areas of the target object is 2, “B” may indicate that the count of doctor visits of the target subject is 10 times, “C” may indicate that the count of serious illnesses of the target subject is 2, “D” may indicate that the severity level of the target object is 1, and “E” may indicate that the count of medical insurance reimbursements of the target object is 5 times, etc.

In some embodiments, the medical insurance collaborative feature 423 may be determined through the medical insurance platform 4012 processing the medical insurance feature 421 of the associated person based on the medical insurance embedded layer 422. For example, the medical insurance platform may input the medical insurance feature of the associated person into the medical insurance embedded layer, and the medical insurance embedded layer may output the medical insurance collaborative feature.

More descriptions about the training process of the medical insurance embedded layer may be found elsewhere in the present disclosure, e.g., FIG. 5 and its relevant descriptions thereof.

In some embodiments, the medical insurance platform may obtain the medical insurance feature of the associated person based on a medical insurance knowledge graph.

The medical insurance knowledge graph may reflect the relationship between multiple people and multiple medical insurance institutions. In some embodiments, the medical insurance knowledge graph may include nodes and edges. The edge of the medical insurance knowledge graph may refer to the relationship between nodes. The nodes may include people nodes and medical insurance institution nodes. The node attributes of a people node may include address information, bank flow, income information, credit data, etc. The node attributes of the medical insurance institution node may include address information, etc.

In some embodiments, the edges of the medical insurance knowledge graph may include multiple types of edges, for example, the immediate family type, the same address type, the medical insurance type, etc. The edge of the medical insurance related type is the edge between the person and the medical insurance institution, which may reflect the relationship between the person and the medical insurance institution. For example, the edge of the medical insurance related type may be configured to describe a person's medical insurance related information. The edge attributes of the medical insurance related types may include the count of doctor visits, the count of serious illnesses, the severity level, the count of medical insurance reimbursements, and the total amount of medical insurance reimbursements, etc. More descriptions about the immediate family type and the same address type may be found elsewhere in the present disclosure, e.g., FIG. 5 and its relevant descriptions thereof.

In some embodiments, the medical insurance platform may obtain the medical insurance feature of the associated person through the medical insurance knowledge graph.

The medical insurance feature of the associated person may include the medical insurance feature of the target object and the medical insurance feature of the related person. In some embodiments, the medical insurance feature of the target object may be obtained through the count of insured areas of the target object, medical insurance related information of each insured area, etc. The medical insurance platform may determine the count of insured areas through the count of edges between the target objects and the medical insurance structure. The medical insurance platform may determine the medical insurance related information of each insured area through the edge attributes between the target object and the corresponding medical insurance institution. For example, the medical insurance platform may query the edge attributes of the target object whose neighbor degree is 1 and the edge type is a medical insurance related type through the medical insurance knowledge graph. The medical insurance platform may further determine the medical insurance related information of each insured area corresponding to the target object.

In some embodiments, the medical insurance platform may input the count of insured areas of the target object and the medical insurance related information of each insured area, etc. into the medical insurance embedded layer. The medical insurance embedded layer may output the medical insurance feature vector of the target object.

In some embodiments, the medical insurance platform may determine the related person of the target object by the neighbor degree between different people and the target object. The medical insurance feature of the related person may be obtained through the count of insured areas of the related person of the target object and the medical insurance related information of each insured area.

In some embodiments, the medical insurance platform may input the obtained count of the insured area of the related person, the related information of each insured area, etc. into the medical insurance embedded layer. The medical insurance embedded layer may output the medical insurance feature vector of the related person.

In some embodiments, the medical insurance platform may obtain the medical insurance collaborative feature by neighbor degree weighting. The obtaining the medical insurance collaborative feature may be similar to the obtaining the social insurance collaborative feature. The only difference is that the obtaining medical insurance collaborative feature is that the medical insurance platform performs neighbor weighting on the medical insurance feature vector. The obtaining social insurance collaborative feature is that the social insurance platform performs neighborhood weighting on the social insurance feature vector. Therefore, for more information about obtaining medical insurance collaborative feature, please refer to the obtaining the social insurance collaborative feature.

In some embodiments of the present disclosure, the medical insurance feature of the target object and the related person may be obtained through the medical insurance knowledge graph to further obtain the medical insurance collaborative feature. Through the above method, the relevant medical insurance information of the target object and related person may be comprehensively considered in various aspects. It saves the need for users to perform pre-order analysis of massive data about medical insurance, which is beneficial to improve the accuracy of the checklist of subsequent target objects. A checklist that is more consistent with the laws of historical data about medical insurance may be obtained through generating a checklist from massive data about medical insurance.

In some embodiments of the present disclosure, different collaborative features may be determined through different collaborative platforms processing different features of the associated person by different embedded layers, which may cause the related information of the target object and related person corresponding to different collaborative platforms to be changed and the true value of the related information to be covered or hidden without being disclosed, so as to ensure the security and confidentiality of the related information of the target object and related person.

FIG. 5 illustrates an exemplary schematic diagram of determining a checklist based on the collaborative feature I according to some embodiments of the present disclosure. As shown in FIG. 5, the process 500 includes the following operations. In some embodiments, the process 500 may be performed by verification management platform 230.

In operation 510, the evaluation value 513 may be determined through processing the collaborative feature based on an evaluation model, and the evaluation model is a machine learning model.

In some embodiments, an evaluation value 513 may be determined through the verification management platform 230 processing the collaborative feature 511 based on an evaluation model 512.

An evaluation model 512 may refer to a model that may determine an evaluation value of a target object. In some embodiments, the evaluation model may be a machine learning model. In some embodiments, the types of evaluation models may include neural network models, deep neural networks, etc. The selection of model types may depend on specific circumstances.

In some embodiments, the input of the evaluation model may include one or more collaborative features. The output of the evaluation model may include the evaluation value of the target object. For example, the evaluation value of the target object may be determined through the evaluation model processing one or more collaborative features.

In some embodiments, the verification management platform 230 may input multiple collaborative features of the target object and related person into the evaluation model. The evaluation model may process multiple collaborative features and may output the evaluation value of the target object. The verification management platform 230 may obtain the evaluation value of the target object output by the evaluation model.

In some embodiments, the input of the evaluation model may also include at least one of the social insurance collaborative features 413 and the medical insurance collaborative features 423. More descriptions about the social insurance collaborative feature and the medical insurance collaborative feature may be found elsewhere in the present disclosure, e.g., FIG. 4 and its relevant descriptions thereof.

In some embodiments, the verification management platform 230 may input the medical insurance collaborative feature and/or social insurance collaborative feature of the target object and related person into the evaluation model. The evaluation model may process the medical insurance collaborative feature and/or the social insurance collaborative feature and output the evaluation value of the target object. The verification management platform 230 may obtain the evaluation value of the target object output by the evaluation model.

In some embodiments of the present disclosure, the verification management platform 230 may determine the evaluation value of the target object through evaluation model. The verification management platform 230 may comprehensively consider the relevant medical insurance and/or social insurance status of the target object and related person, which is beneficial to improve the accuracy of the evaluation value of the target object.

In some embodiments, the evaluation model may be obtained by training based on multiple sets of training samples and labels.

In some embodiments, the training samples include multiple sets of sample collaborative features. The label may be the sample evaluation value of the target object. The training samples may be obtained based on historical data. For example, the verification management platform may take the collaborative feature of a target object and the collaborative feature of related person of the target object in the historical data as a set of sample collaborative features. Multiple target objects may be included in the historical data. Each target object has its corresponding collaborative feature of the target object and the collaborative feature of the related person of the target object. The verification management platform may obtain the collaborative feature of multiple sets of samples. The labels of training samples may be determined by manual labeling or automatic labeling. For example, the verification management platform may label the actual evaluation value of the target object as the label of the training sample.

In some embodiments, the evaluation model may be obtained through a joint multi-party security training of multiple embedded layers and the evaluation model.

Multiple embedded layers may refer to respective embedded layers of multiple collaborative platforms. The joint multi-party security training may refer to the training of the evaluation model through the joint participation of multiple participants.

In some embodiments, the verification management platform may obtain collaborative feature through multiple collaborative platforms. Different collaborative features may be determined through multiple collaborative platforms processing different features of target object and related person by their respective embedded layers. In some embodiments, the verification management platform may obtain the evaluation model through joint multi-party security training of multiple embedded layers and the evaluation model.

In some embodiments, the evaluation model may be obtained by training based on multiple sets of training samples and labels.

In some embodiments, the training samples include multiple sets of sample collaborative features. The label may be the sample evaluation value of the target object. Training samples may be obtained from data from multiple different people. For example, a verification management platform may obtain data on multiple people. Multiple people may include people without a fraud record, people with a fraud record, etc. The verification management platform may determine the abovementioned different people as multiple sample target objects. The verification management platform may send the information of multiple sample target objects to multiple different collaborative platforms.

Different collaborative platforms may obtain the collaborative features of different aspects of the sample target objects and the related persons of the sample target objects by their corresponding embedded layers. For example, the medical insurance platform may obtain the medical insurance collaborative feature. Different collaborative platforms may send the obtained sample target objects and different aspects of collaborative features of the related person of the sample target objects to the verification management platform.

The verification management platform may take one sample target object and the collaborative feature of the related person of the sample target object as a set of sample collaborative features. Each sample target object has its corresponding collaborative features of the sample target object and the collaborative feature of the related person of the sample target object. The verification management platform may obtain multiple sets of samples collaborative features.

The labels of the training sample may be determined by manual labeling or automatic labeling. For example, the verification management platform may manually mark the sample target object and other information about their related person. Exemplarily, for a sample target object without a fraud record and its related person, the verification management platform may mark the label of the training sample corresponding to the sample target object as a normal value. For sample target object with a fraud record and its related person, the verification management platform may mark the label of the training sample corresponding to the sample target object as a higher evaluation value. For sample target object and their related person who have been brave and/or commended, the verification management platform may mark the label of the training sample corresponding to the sample target object as a very low evaluation value.

In some embodiments of the disclosure, through multi-party security training, it may be ensured that different information of the target object and related person may be not disclosed so as to guarantee the security of the information of the target object and related person.

In some embodiments, a social insurance management platform, a medical insurance management platform, and the verification management platform, which are as one of the multi-parties respectively, conduct collaborative training. The social insurance management platform may obtain a social insurance embedded layer. The medical insurance management platform may obtain the medical insurance embedded layer. The verification management platform may obtain an evaluation model. More descriptions about the social insurance embedded layer and the medical insurance embedded layer may be found elsewhere in the present disclosure, e.g., FIG. 4 and its relevant descriptions thereof.

Multi-parties may refer to the respective management platforms corresponding to multiple collaborative platforms. For example, the management platform corresponding to the social insurance collaborative platform may be a social insurance management platform. For another example, the management platform corresponding to the medical insurance platform may be a medical insurance management platform.

The social insurance management platform may refer to the Internet of Things platform that performs overall management on multiple social insurance institutions. The medical insurance management platform may refer to the Internet of Things platform that performs overall management on multiple medical insurance institutions.

Collaborative training may refer to the collaborative training of multiple management platforms. Through collaborative training, different management platforms may obtain their own models. For example, a social insurance management platform may obtain a social insurance embedded layer. The medical insurance management platform may obtain the medical insurance embedded layer. The verification management platform may obtain the evaluation model.

In some embodiments, the social insurance embedded layer, the medical insurance embedded layer, and the evaluation model may be obtained based on multiple sets of training samples and training labels.

In some embodiments, the training samples may include multiple sets of sample target objects and related persons of the sample target objects. The label may be the sample evaluation value of the target object. Training samples may be obtained from data from multiple different people. For example, a verification management platform may obtain data on multiple persons. The verification management platform may determine the abovementioned different people as multiple sample target objects.

The verification management platform may send the information of multiple sample target objects to the social insurance management platform and the medical insurance management platform. The social insurance embedded layer may obtain the social insurance collaborative feature of the sample target object and the social insurance collaborative feature of the related person of the sample target object based on the information of the sample target object. The medical insurance embedded layer may obtain the medical insurance collaborative feature of the sample target object and the medical insurance collaborative feature of the related person of the sample target object based on the information of the sample target object.

The verification management platform may regard the same sample target object and the related person of the sample target object as a set of sample target objects and the related persons of the sample target objects. Each sample target object may have its own related person corresponding to the sample target object. The verification management platform may obtain multiple sets of sample target objects and related persons of the sample target objects.

In some embodiments, different collaborative platforms send the obtained sample target objects and different aspects of collaborative features of the related persons of the sample target objects to the verification management platform. The verification management platform may input the collaborative feature of the sample target object and the related person of the sample target object into the evaluation model. The labels of training sample may be determined by manual labeling or automatic labeling.

The training of the social insurance embedded layer, the medical insurance embedded layer, and the evaluation model may include one or more iterative updates. Each iterative update may include updating the social insurance embedded layer and the model parameters of the medical insurance embedded layer and the evaluation model based on the training samples. The social insurance embedded layer with the updated parameters may obtain the updated social insurance collaborative feature. The medical insurance embedded layer with the updated parameters may obtain the updated medical insurance collaborative features. The evaluation model with the updated parameters may obtain the updated evaluation values.

In some embodiments, the optimization objectives of the social insurance embedded layer, the medical insurance embedded layer, and the training of the evaluation model may include adjusting model parameters such that the value of the corresponding loss function becomes smaller. The loss function may be configured to characterize the difference between evaluation value predicted by the mode and the evaluation value of the sample. In some embodiments, when the social insurance embedded layer, the medical insurance embedded layer, and the evaluation model satisfy the termination condition in an iterative update, the training may be stopped. For example, when the difference between the evaluation value predicted by the model and the evaluation value of the sample is less than a preset threshold, the training is stopped. The social insurance management platform may obtain the social insurance embedded layer. The medical insurance management platform may obtain the medical insurance embedded layer. The verification management platform may obtain the evaluation model.

In some embodiments of the disclosure, through multi-party collaborative training, different management platforms may obtain different corresponding models. Through joint multi-party training, it is beneficial to further improve the accuracy of the subsequent checklist.

In operation 520, the checklist corresponding to the query request may be determined based on the evaluation value.

In some embodiments, the verification management platform 230 may determine the evaluation value corresponding to each target object based on the evaluation model. The verification management platform may rank based on the evaluation value corresponding to each target object, and generate a checklist corresponding to the query request. For example, the verification management platform may generate a checklist by ranking from small to large based on the size of the evaluation value. The verification management platform may further obtain a checklist ranked by evaluation values from small to large, and the checklist corresponds to the user's query request.

In some embodiments of the present disclosure, the evaluation value is determined by the evaluation model, and the checklist corresponding to the query request is determined based on the evaluation value, which can improve the accuracy of the evaluation value of the target object and further ensure the accuracy of the checklist.

It should be noted that the above description about the flow is only for example and illustration and does not limit the present to carry out various modifications and changes. However, these corrections and changes are still within the scope of the disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure and within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. Furthermore, the particular feature, structures or feature may be combined as suitable in one or more embodiments of the present disclosure.

Additionally, the order in which elements and sequences of the may process described herein are processed, the use of alphanumeric characters, or the use of other designations, is not intended to limit the order of the may process and methods described herein, unless explicitly claimed. While various presently contemplated embodiments of the invention have been discussed in the foregoing disclosure by way of example, it is to be understood that such detail is solely for that purpose and that the appended claims are not limited to the disclosed embodiments, but, on the contrary, are intended to cover all modifications and equivalent arrangements that are within the spirit and scope of the embodiments herein. For example, although the system components described above may be implemented by hardware devices, they may also be implemented by software-only solutions, such as installing the described system on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more feature than are expressly recited in each claim. Rather, claimed subject matter may lie in less than all feature of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

For each patent, patent present disclosure, patent present disclosure publications and other materials referenced in the present disclosure, such as articles, books, instructions, publications, documents, etc., here, all of them will be incorporated herein by reference. Except for the present disclosure history documentation of the present disclosure or the conflict, there is also an except for documents (current or after the present disclosure), which are available in the present disclosure. It should be noted that, if there is any inconsistency or conflict between the descriptions, definitions and/or use of terms in the accompanying materials of the specification and the contents of the specification, the descriptions, definitions and/or use of terms in this specification shall prevail.

Finally, it should be understood that the embodiments described in the present disclosure are intended to illustrate the principles of the embodiments of the present disclosure. Other deformations may also belong to the scope of the present disclosure. Thus, as an example, not limited, the alternative configuration of the present disclosure embodiment may be consistent with the teachings of the present disclosure. Accordingly, the embodiments of the present disclosure are not limited to the embodiments of the present disclosure clearly described and described.

What is claimed is:

1. A method for generating a checklist in a smart city based on an Internet of Things, wherein the method is executed by a verification management platform, and the method includes:
obtaining a query request through a user platform based on a service platform;
obtaining associated person information based on a population information platform, wherein the associated person information includes target object information and related person information;
obtaining a collaborative feature through a collaborative platform based on the associated person information;
determining a checklist corresponding to the query request based on the collaborative feature; and
feedbacking the checklist to a user through the user platform based on the service platform.

2. The method according to claim 1, wherein the obtaining a collaborative feature through a collaborative platform based on the associated person information includes:
determining the collaborative feature through the collaborative platform processing collaborative information of associated person by an embedded layer.

3. The method according to claim 2, wherein the collaborative platform includes at least one of a social insurance platform and a medical insurance platform;
the determining the collaborative feature through the collaborative platform processing collaborative information of associated person by an embedded layer includes:
determining a social insurance collaborative feature through the social insurance platform processing a social insurance feature of associated person by a social insurance embedded layer; and
determining a medical insurance collaborative feature through the medical insurance platform processing a medical insurance feature of the associated person by a medical insurance embedded layer.

4. The method according to claim 1, wherein the determining a checklist corresponding to the query request based on the collaborative feature includes:
determining an evaluation value through processing the collaborative feature based on an evaluation model, wherein the evaluation model is a machine learning model; and
determining the checklist corresponding to the query request based on the evaluation value.

5. A system for generating a checklist in a smart city based on an Internet of Things, wherein the system includes a user platform, a service platform, and a verification management platform, and the verification management platform is configured to perform operations comprising:
obtaining a query request through the user platform based on the service platform;
obtaining associated person information based on a population information platform, wherein the associated person information includes target object information and related person information;
obtaining a collaborative feature through a collaborative platform based on the associated person information;
determining a checklist corresponding to the query request based on the collaborative feature; and
feedbacking the checklist to a user through the user platform based on the service platform.

6. The system according to claim 5, wherein the verification management platform is configured to further perform operations including:
determining the collaborative feature through the collaborative platform processing the collaborative information of associated person by an embedded layer.

7. The system according to claim 6, wherein the collaborative platform includes at least one of a social insurance platform and a medical insurance platform, and
the verification management platform is configured to further perform operations including:
determining a social insurance collaborative feature through the social insurance platform processing a social insurance feature of associated person by a social insurance embedded layer; and
determining a medical insurance collaborative feature through the medical insurance platform processing a medical insurance feature of the associated person by a medical insurance embedded layer.

8. The system according to claim 5, wherein the verification management platform is configured to further perform operations including:
determining an evaluation value through processing the collaborative feature based on an evaluation model, wherein the evaluation model is a machine learning model; and
determining the checklist corresponding to the query request based on the evaluation value.

9. A non-transitory computer-readable storage medium storing computer instructions, wherein when reading the computer instructions in the storage medium, a computer executes a method for generating a checklist in a smart city based on an Internet of Things according to claim 1.
